(19) United States
(12) Patent Application Publication
(10) Pub. No.: US 2025/0327453 A1
(43) Pub. Date: Oct. 23, 2025

(54) VALVE-AND-PUMP MODULE FOR THERMAL MANAGEMENT SYSTEM

(71) Applicant: LITENS AUTOMOTIVE PARTNERSHIP, Woodbridge (CA)

(72) Inventors: John R. ANTCHAK, Aurora (CA); Christopher MACPHAIL, Toronto (CA); Antony GREENHALGH, Toronto (CA); Nikunj Rashmikant PATEL, Nobleton (CA); Steven ZUCCATO, Vaughan (CA); Kody A ORR, Etobicoke (CA); Evan J. HURRY, Holland Landing (CA)

(21) Appl. No.: 19/172,634

(22) Filed: Apr. 7, 2025

Related U.S. Application Data
(63) Continuation-in-part of application No. PCT/CA2023/051339, filed on Oct. 10, 2023.
(60) Provisional application No. 63/378,760, filed on Oct. 7, 2022.
(60) Provisional application No. 63/704,416, filed on Oct. 7, 2024.

(51) Int. Cl. F04D 13/06; B60K 11/02; F16K 11/087; F16K 31/04

(52) U.S. Cl. CPC F04D 13/06; F16K 11/0873; F16K 31/047; B60K 11/02

(57) ABSTRACT

In an aspect, a valve-and-pump module for controlling a flow of coolant in a thermal management system for a vehicle is provided. The valve-and-pump module includes a valve-and-pump module housing, a valve member, a valve actuator, a pump impeller and a pump driver.

### CROSS-REFERENCE TO RELATED APPLICATIONS

This application claims the benefit of and priority to PCT application PCT/CA2023/051339, filed on Oct. 10, 2023, which claims the benefit of U.S. provisional patent application No. 63/378,760, filed on Oct. 7, 2022. Additionally, this application claims the benefit of and priority to U.S. Provisional application 63/704,416, filed Oct. 7, 2024. The contents of all of the above noted applications are incorporated by reference in this application in their entirety, where permitted.

### FIELD

The specification relates generally to thermal management systems for electric vehicles and more particularly to thermal management systems incorporating both valves and pumps for directing coolant flow in an electric vehicle.

### BACKGROUND OF THE DISCLOSURE

It is known to provide thermal management systems for electric vehicles in which excess heat generated by one component is used by another component that requires heating. However, some such systems are complex and involve a large number of components such as valves and pumps, and have many seals and components, with associated complications in assembly, and high pressure drops. Improved valves and pumps are desirable.

### SUMMARY OF THE DISCLOSURE

In an aspect, a valve-and-pump module for controlling a flow of coolant in a thermal management system for a vehicle. The valve-and-pump module includes a valve-and-pump module housing, a valve member, a valve actuator, a pump impeller and a pump driver. The valve-and-pump module housing defines a valve chamber, and has a plurality of valve inlets and a valve outlet. The valve member is positioned in the valve chamber and has at least one pass-through aperture. The valve member is rotatable about a valve member axis between a first position in which the at least one pass-through aperture fluidically connects the plurality of valve inlets to the valve outlet in a first way to provide a first flow arrangement through the coolant transport system, and a second position in which the at least one pass-through aperture fluidically connects the plurality of valve inlets to the valve outlet in a second way to provide a second flow arrangement through the coolant transport system that is different than the first flow arrangement. The at least one pass-through aperture has at least one inlet end and at least one outlet end, and extends radially inward from the at least one inlet end towards the valve member axis and axially inward from the at least one outlet end. The valve actuator includes a valve actuator motor, and a valve actuator gear arrangement that includes a final gear that is positioned for rotation about the valve member axis and is operatively connected to the valve member to rotate the valve member between the first and second positions. The valve actuator is on a first axial side of the valve member. The valve-and-pump module housing defines a pump chamber having a volute. The valve-and-pump module housing has a pump inlet that extends axially and a pump outlet that extends tangentially. The pump inlet is coaxial with and fluidically connected to the valve outlet. The pump impeller is positioned in the pump chamber for rotation about a pump impeller axis that is coaxial with the valve member axis. The pump impeller is shaped so as to drive coolant from the pump inlet through the volute to the pump outlet. The pump driver includes an axial flux motor including a stator that is connected to the valve-and-pump module housing, and a rotor that is connected to and coaxial with the pump impeller. The rotor is rotatable by energizing the stator, to drive rotation of the pump impeller.

In another aspect, a valve-and-pump module is provided for controlling a flow of coolant in a thermal management system for a vehicle. The valve-and-pump module includes a valve-and-pump module housing, a valve member, a valve outlet seal member, a valve actuator, a pump impeller and a pump driver. The valve-and-pump module housing defines a valve chamber, and has at least one valve inlet, and a plurality of valve outlets. The valve member is positioned in the valve chamber, and is rotatable about a valve member axis between a first position and a second position. The valve member includes a plurality of valve member spherical portions, each including a valve pass-through aperture. The valve pass-through apertures are oriented such that rotation of the valve member to the first position fluidically connects the at least one valve inlet to the plurality of valve outlets in a first way to provide a first flow arrangement through the coolant transport system, and such that rotation of the valve member to the second position fluidically connects the at least one valve inlet to the plurality of valve outlets in a second way to provide a second flow arrangement through the coolant transport system that is different than the first flow arrangement. Each of the valve member spherical portions is positioned in an associated spherical sub-chamber defined by a sub-chamber wall. The valve outlet seal member is positioned between each of the valve member spherical portions and the sub-chamber wall of the associated spherical sub-chamber so as to form an outlet seal therebetween. The valve outlet seals are circular. The valve actuator includes a valve actuator motor, and a valve actuator gear arrangement that includes a final gear that is positioned for rotation about the valve member axis and is operatively connected to the valve member to rotate the valve member between the first and second positions. The valve-and-pump module housing defines a pump chamber having a volute and defining a pump axis. The valve-and-pump module housing has a pump inlet that extends axially along the pump axis and a pump outlet that extends tangentially relative to the volute and is fluidically upstream from the at least one valve inlet. The pump impeller is positioned in the pump chamber for rotation about the pump axis. The pump impeller is shaped so as to drive coolant from the pump inlet through the volute to the pump outlet. The pump driver includes an axial flux motor including a stator that is connected to the valve-and-pump module housing, and a rotor that is connected to and coaxial with the pump impeller, wherein the rotor is rotatable by energizing the stator, to drive rotation of the pump impeller.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings.

FIG. 1 is a schematic illustration of a thermal management system for an electric vehicle including a valve-and-pump module in accordance with a first embodiment of the present disclosure.

FIG. 2 is a perspective view of the valve-and-pump module shown in FIG. 1.

FIG. 3 is a sectional side view of the valve-and-pump module shown in FIG. 2.

FIG. 4 is a sectional perspective view of a portion of the valve-and-pump module shown in FIG. 2.

FIG. 5A is a perspective view of a valve member from the valve-and-pump module shown in FIG. 2, in a first position.

FIG. 5B is a perspective view of the valve member from the valve-and-pump module shown in FIG. 2, in a second position.

FIG. 6 is a plan view of a valve actuator from the valve-and-pump module shown in FIG. 2.

FIG. 7 is a magnified sectional side view of a seal member that forms a seal between the valve member and an associated valve inlet conduit from the valve-and-pump module shown in FIG. 2.

FIG. 8 is a perspective view of an alternative embodiment of the valve-and-pump module housing, showing three valve inlets that are each 120 degrees apart circumferentially.

FIG. 9 is a side elevation view of an electric vehicle incorporating the valve and the thermal management system.

FIG. 10 is a perspective view of a valve-and-pump module in accordance with another aspect of the present disclosure.

FIG. 11 is an exploded perspective view of the valve-and-pump module shown in FIG. 10.

FIG. 12 is another perspective view of the valve-and-pump module shown in FIG. 10, witch a portion of a housing of the valve-and-pump module cut away.

FIG. 13 is a perspective view of a valve member from the valve-and-pump module shown in FIG. 10 in one of a plurality of positions.

FIG. 14 is a perspective view of the valve member from the valve-and-pump module shown in FIG. 10 in another one of the plurality of positions.

FIG. 15 is a perspective view of the valve member from the valve-and-pump module shown in FIG. 10 in yet another one of the plurality of positions.

FIG. 16 is a perspective view of the valve member from the valve-and-pump module shown in FIG. 10 in yet another one of the plurality of positions.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The indefinite article “a” is not intended to be limited to mean “one” of an element. It is intended to mean “one or more” of an element, where applicable, (i.e. unless in the context it would be obvious that only one of the element would be suitable).

Any reference to upper, lower, top, bottom or the like is intended to refer to an orientation of a particular element during use of the claimed subject matter and not necessarily to its orientation during shipping or manufacture. The upper surface of an element, for example, can still be considered its upper surface even when the element is lying on its side.

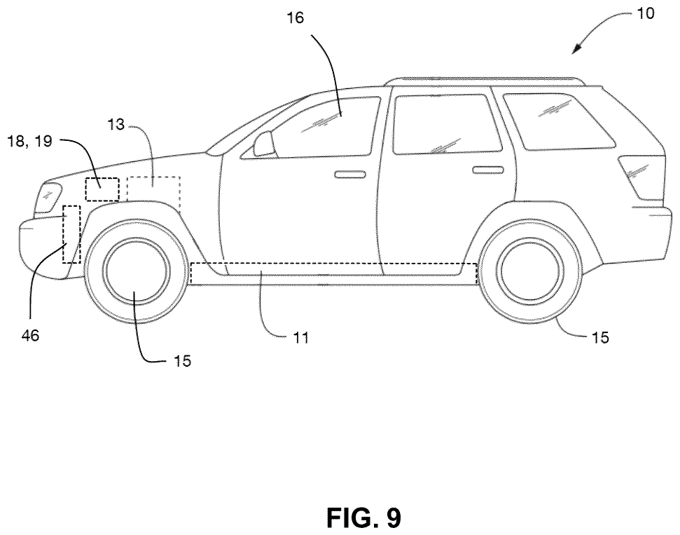

Reference is made to FIG. 9, which shows an electric vehicle 10. The term ‘electric vehicle’ is intended to include any vehicle that includes an electric motor 13 that drives one or more wheels 15 of the electric vehicle 10. The electric motor 13 may also be referred to as the traction motor 13, to distinguish it over other electric motors that may be present in the electric vehicle 10 for driving movement of minor elements of the electric vehicle 10 such as seats and windows and the like. The electric vehicle 10 includes a battery pack 11 for storing and releasing charge for use by the traction motor 13. The battery pack 11 may also be referred to as the battery 11 for simplicity. The battery pack 11 may incorporate a plurality of any suitable type of storage cells, such as pouch cells, cylindrical cells, other types of cells, or any combination thereof. The electric vehicle 10 may also include any other suitable type of energy storage device, in addition to the battery pack 10. The electric vehicle 10 further includes a passenger cabin shown at 16. The electric vehicle 10 further includes an ECU (electronic control unit) 18 that controls operation of various components of the electric vehicle 10. The ECU 18 may be part of a control system 19, that may include several additional controllers in addition to the ECU 18.

### General Description of Thermal Management System

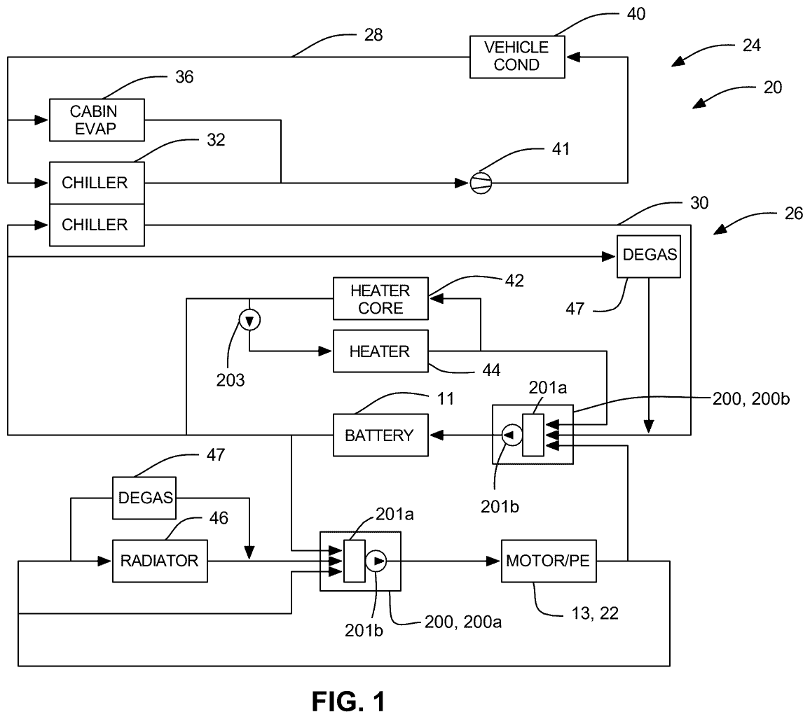

Reference is made to FIG. 1, which shows a thermal management system 20 for the electric vehicle 10. The thermal management system 20 is used for controlling a temperature of a plurality of thermal loads 22 in an electric vehicle 10, including, for example the traction motor 13, and the battery pack 11. For the purposes of the present disclosure, the traction motor 13 as a thermal load may include both the motor itself and the attendant power electronics including the inverter to convert DC current from the battery pack 11 to AC current for driving the traction motor 13.

The thermal management system 20 includes a refrigerant transport system 24 for transporting refrigerant, and a coolant transport system 26 for transporting coolant. The refrigerant is shown at by the conduits 28 in FIG. 1A and the coolant is represented by the conduits 30.

The refrigerant transport system 24 includes a chiller 32 with an expansion valve upstream therefrom, a cabin evaporator 36, and a condenser 40. The chiller 32 receives the refrigerant 28 and evaporates the refrigerant 30. The chiller 32 is also positioned to receive coolant 30 from the coolant transport system 26 and to cool the coolant 30 by the evaporation of the refrigerant 28 in the chiller 32.

Conversely, the condenser 40 is positioned to receive the coolant 30 from the coolant transport system 26 and to heat the coolant 30 by condensation of the refrigerant 28 in the condenser 40.

A compressor, shown at 41, increases the pressure of the refrigerant 28 and drives the flow of refrigerant 28 through the refrigerant transport system 24.

The coolant transport system 26 further includes a cabin heater core 42 positioned to use the coolant 30 in order to heat an air flow to the passenger cabin 16 of the electric vehicle 10, a coolant heater 44 positioned to heat the coolant 30 by electric resistance heating, and a radiator 46 positioned to cool the coolant. The coolant heater 44 may be any suitable type of heater, such as a PTC heater and may be positioned immediately upstream from the cabin heater core 42. The radiator may be positioned near the front of the electric vehicle 10 so as to receive an air flow entering the electric vehicle 10 from the front end of the electric vehicle 10.

Degas tanks shown at 47 may be provided where suitable, as will be understood by one skilled in the art.

The thermal management system 20 may include at least one valve-and-pump module 200. In the example embodiment shown in FIG. 1, there is a first valve-and-pump module 200a and a second valve-and-pump module 200b.

### General Description of Valve-and-Pump Module

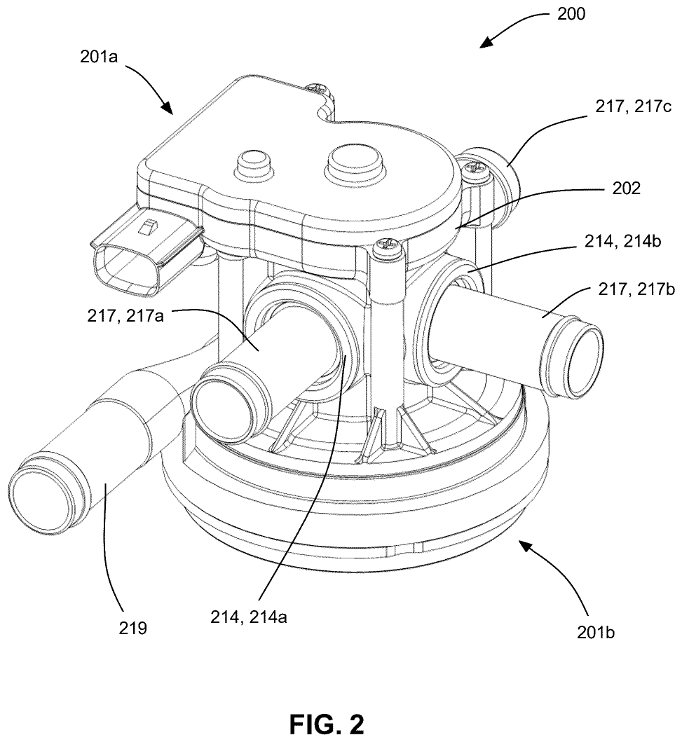

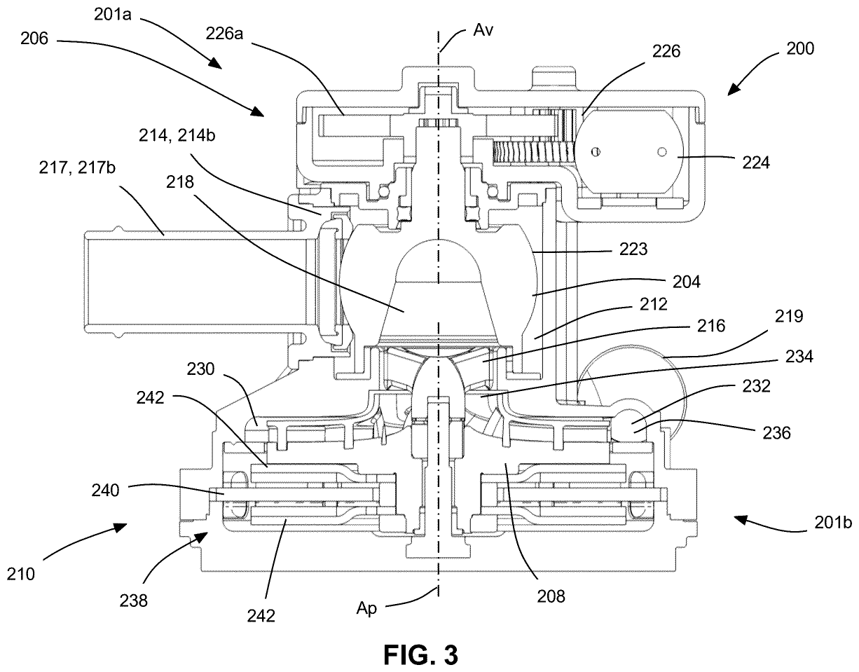

With reference to FIGS. 2 and 3, each valve-and-pump module 200 includes a valve 201a and a pump 201b. In the embodiment shown, the valve-and-pump module 200 includes a valve-and-pump module housing 202 (that is part of both the valve 201a and the pump 201b), and further includes a valve member 204, a valve actuator 206, a pump impeller 208 and a pump driver 210.

The valve-and-pump module housing 202 defines a valve chamber 212, and has a plurality of valve inlets 214 and a valve outlet 216. In the example shown, the valve includes three valve inlets 214, shown individually at 214a, 214b, and 214c. For each of the valve inlets 214 there may be an optionally provided valve inlet conduit 217, and for the valve outlet 216 there may be an optionally provided valve outlet conduit 219. As shown there are three valve inlet conduits 217a, 217b and 217c, which mate sealingly with the three valve inlets 214a, 214b, and 214c, respectively, and the valve outlet conduit 219, which mates sealingly with the valve outlet 216.

The valve member 204 controls the flow of coolant through the valve 201a and therefore through the valve-and-pump module 200. The valve member 204 is positioned in the valve chamber 212 and has at least one pass-through aperture 218. The at least one pass-through aperture 218 has at least one inlet end 220 and at least one outlet end 222, and may optionally extend radially inward from the at least one inlet end 220 towards the valve member axis Av and axially inward from the at least one outlet end 222.

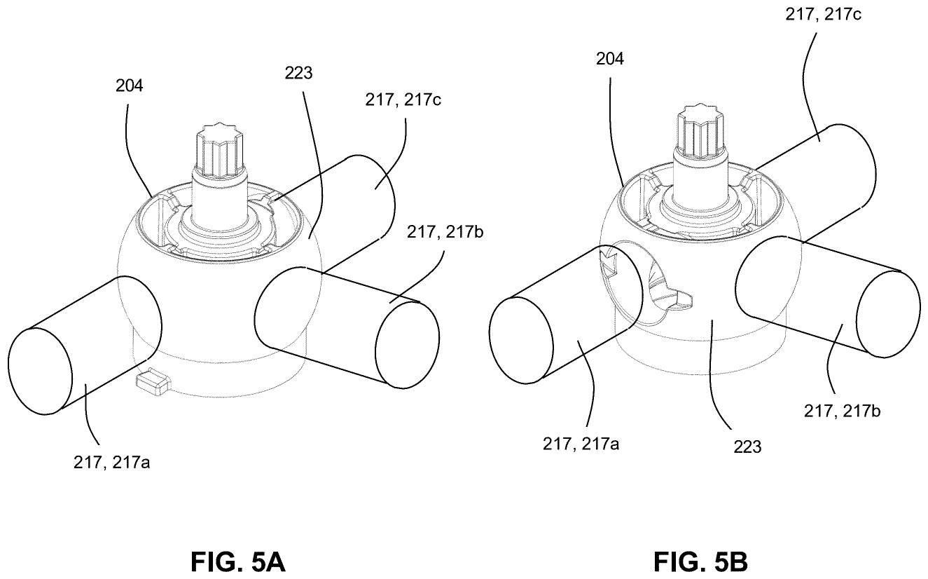

The valve member 204 is rotatable about a valve member axis Av between a first position (FIG. 5A) in which the at least one pass-through aperture 218 fluidically connects the plurality of valve inlets 214 to the valve outlet 216 in a first way to provide a first flow arrangement through the coolant transport system 26, and a second position (FIG. 5B) in which the at least one pass-through aperture 218 fluidically connects the plurality of valve inlets 214 to the valve outlet 216 in a second way to provide a second flow arrangement through the coolant transport system 26 that is different than the first flow arrangement. An example is shown in FIGS. 5A and 5B. In FIG. 5A, the valve member 204 connects the valve inlet 214c with the valve outlet 216. In FIG. 5B, the valve member 204 connects the valve inlet 214a with the valve outlet 216. It will be noted that the valve inlet conduits 217a, 217b and 217c in FIGS. 5A and 5B are shown in transparent outline only, for illustrative purposes, and so as not to obscure the valve member 204 itself. The first and second positions for the valve member 204 as shown may wholly cut off flow from one of the valve inlets 214 and open flow from another one of the valve inlets 214. However, in some embodiments, the first and second positions for the valve member 204 may both permit some flow from a particular valve inlet 214 to the valve outlet 216, but may change the amount of flow that is permitted. Both of these examples of first and second positions constitute fluidically connecting the plurality of valve inlets 214 to the valve outlet 216 in a second way to provide a second flow arrangement through the coolant transport system 26 that is different than the first flow arrangement.

The valve member 204 may have any suitable shape. For example, the valve member 204 may have an exterior surface 223 that is generally spherical.

The valve actuator 206 includes a valve actuator motor 224, and a valve actuator gear arrangement 226 that includes a final gear 226a that is positioned for rotation about the valve member axis Av and is operatively connected to the valve member 204 to rotate the valve member 204 between the first and second positions. As can be seen in FIG. 3, the valve actuator 206 is on a first axial side of the valve member 204.

The valve actuator gear arrangement 226 further includes an initial gear 226b, which may be a worm 233. The worm 233 includes a flight 235 that is shaped so as to be non-backdrivable so as to permit the valve actuator motor 224 to hold the valve member 204 in one of the first and second positions while the valve actuator motor 224 is deenergized.

The valve-and-pump module housing 202 further defines a pump chamber 230 having a volute 232. The valve-and-pump module housing 202 has a pump inlet 234 that extends axially and a pump outlet 236 that extends tangentially. The pump inlet 234 is coaxial with and fluidically connected to the valve outlet 216.

The pump impeller 208 is positioned in the pump chamber 230 for rotation about a pump impeller axis Ap that is coaxial with the valve member axis Av. The pump impeller 208 is shaped so as to drive coolant from the pump inlet 234 through the volute to the pump outlet 236. The pump impeller 208 may have any suitable shape for driving the coolant 30 in this manner.

The pump driver 210 may have any suitable structure for driving operation of the pump impeller 208. In the example shown, the pump driver 210 includes an axial flux motor 238 including a stator 240 that is connected to the valve-and-pump module housing 202, and a rotor 242 that is connected to and coaxial with the pump impeller 208. The rotor 242 is rotatable by energizing the stator 240, as is known in the art of motors, in order to drive rotation and therefore operation of the pump impeller 208. In the embodiment shown, there are two rotors 242, each of which is connected to and coaxial with the pump impeller 208. Thus, it can be said that the pump driver 210 includes at least one stator 240 and at least one rotor 242.

The at least one stator 240 and the at least one rotor 242 may be PCBs, which provides reduced axial length for the pump driver 210 as compared to some actuators of the prior art. Optionally, the at least one stator 240 and the at least one rotor 242 are positioned in the pump chamber 230 and are therefore exposed to the coolant 30.

The pump impeller 208 and the pump driver 210 are positioned on a second axial side of the valve member 204.

The valve-and-pump module housing 202 in the embodiment shown, includes a single contiguous valve-to-pump member 202a that defines at least part of the valve chamber 212, the valve inlets 214, the valve outlet 216, at least part of the pump chamber 230, the pump inlet 234, and the pump outlet 236.

By providing the valve-and-pump module 200, a number of conduits (e.g. hoses), couplings, seal members and other components are eliminated. Additionally, the overall pressure drop that is present in the coolant system 26 is reduced as compared to a prior art system. By providing the single continuous valve-to-pump member 202a, even fewer components such as seals are needed, thereby reducing the assembly time for the thermal management system 20, and increasing its reliability.

In addition to the single contiguous valve-to-pump member 202a, the valve-and-pump module housing 202 may further include a valve chamber cover 202b, and a valve actuator housing 202c, that mounts to the single contiguous valve-to-pump member 202a and forms a seal against the valve chamber cover 202b to prevent leakage of coolant therebetween. The valve actuator housing 202c itself may include a plurality of housing member, such as a first valve actuator housing member 202d, and a second valve actuator housing member 202e which sealingly mate together. By providing the separate valve actuator housing 202c, it is possible to assemble the valve actuator 206 prior to installing it to other elements of the valve-and-pump module 200, such as to the single contiguous valve-to-pump member 202a.

Based on the above description, it can be seen that the valve 201a includes the valve member 204, the valve actuator 206 and the portions of the valve-and-pump module housing 202 that house the valve member 204 and the valve actuator 206, and it can be further seen that the pump 201b includes the pump impeller 208 and the pump driver 210 and the portions of the valve-and-pump module housing 202 that house the pump impeller 208 and the pump driver 210.

As can be seen in FIG. 1, the pumps 201b of the valve-and-pump modules 200 are provided for driving circulation of the coolant 30 in the coolant transport system 26. The pump 201b that is part of the first valve-and-pump module 200a drives coolant flow through the traction motor 13. The pump 201b that is part of the second valve-and-pump module 200b drives coolant flow through the battery pack 11. In the example shown, in addition to the pumps 201b provided as part of the first and second valve-and-pump modules 200a and 200b, there is a third pump shown at 203 that is provided in another region of the coolant transport system 26, positioned to pump coolant through a heater 44.

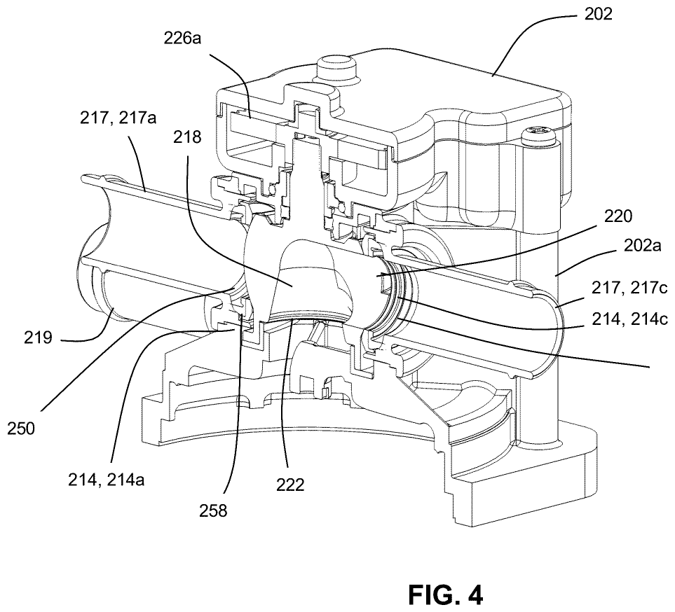

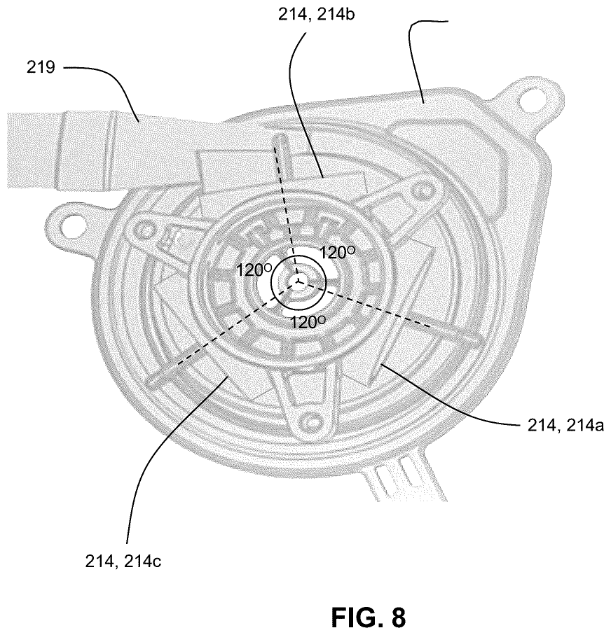

In the embodiment shown in FIGS. 2-5B, the three valve inlets 214 are 90 degrees apart circumferentially about the valve member axis Av. In an alternative embodiment, shown in FIG. 8, the three valve inlets 214 may be positioned 120 degrees apart circumferentially about the valve member axis Av. As a result, the forces acting on the valve member 204 by such causes as the coolant pressure, and any seals acting against the valve member 204 will be balanced, so as to reduce any net force acting on the valve member 204.

While the valve-and-pump module 200 is shown as having three valve inlets 214 and one valve outlet 216, it is possible for the valve-and-pump module 200 to have any suitable number of valve inlets 214 that is a plurality of valve inlets 214. For example, the valve-and-pump module 200 may have two valve inlets 214 and one valve outlet 216.

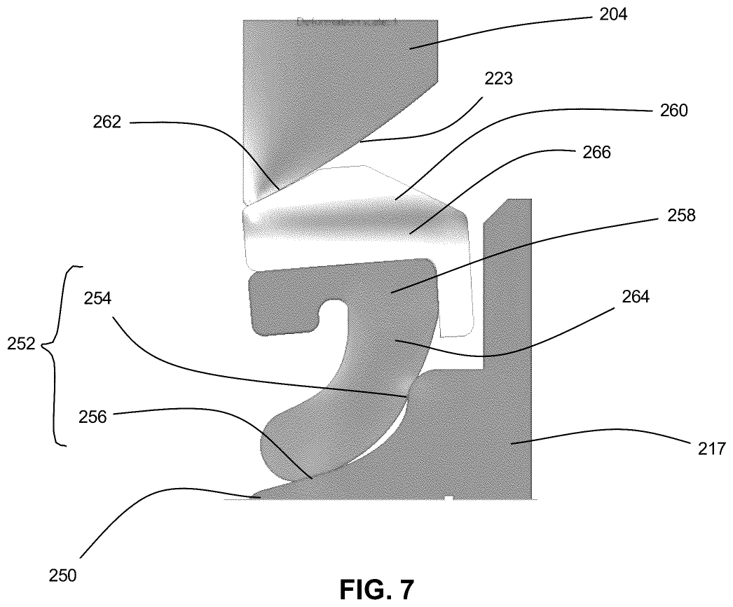

The valve-and-pump module 200 includes a sealing arrangement between the valve member 200 and between each of the valve inlet conduits 217. For each valve inlet conduit 217, there is a conduit outlet 250. The valve inlet conduit 217 further includes an outlet-surrounding surface 252 that surrounds the conduit outlet 250. A magnified view of the conduit outlet 250 is shown in FIG. 7. The first outlet-surrounding surface 252 may be referred to as a seal support surface 252 and extends from a high region 254, and is sloped towards a low region 256. The low region 256 is at greater depth into the seal support surface 252 than is the high region 254, and is closer to the conduit outlet 250 than is the high region 254. A seal member 258 is provided and includes a seal member body 260 having a valve member engagement surface 262 positioned to slidingly engage the exterior surface 223 of the valve member 204. The seal member 258 further includes a leg 264. The leg 264 is engaged with the outlet-surrounding surface 252 and is flexed in bending by engagement therewith.

Optionally, the seal member 258 is made from a first material at the valve member engagement surface 262, which has a first coefficient of friction Cf1 with the valve member 204, and the leg 264 is made from a second material, which has a second coefficient of friction Cf2 with the seal support surface 252. The second coefficient of friction Cf2 is higher than the first coefficient of friction Cf1, which helps to hold the seal member 258 in place on the first seal support surface 252 during movement of the valve member 204 between the first and second positions.

Optionally, the seal member 258 is made from PTFE at the valve member engagement surface 262. For example, the seal member body 260 may include a layer of PTFE shown at 266, that defines the valve member engagement surface 262. For the purpose of sealing effectively and providing good grip on the seal support surface 252, the leg 264 may be made from a suitable sealing material such as, for example, a suitable rubber such as EPDM.

By flexing the leg 264 in bending as opposed to simple compression, the seal member 258 is much better able to accommodate tolerance stack up that may exist in the dimensions of the various components of the valve-and-pump module 200, without resulting in an impractically low or impractically high seal force against the seal support surface 252.

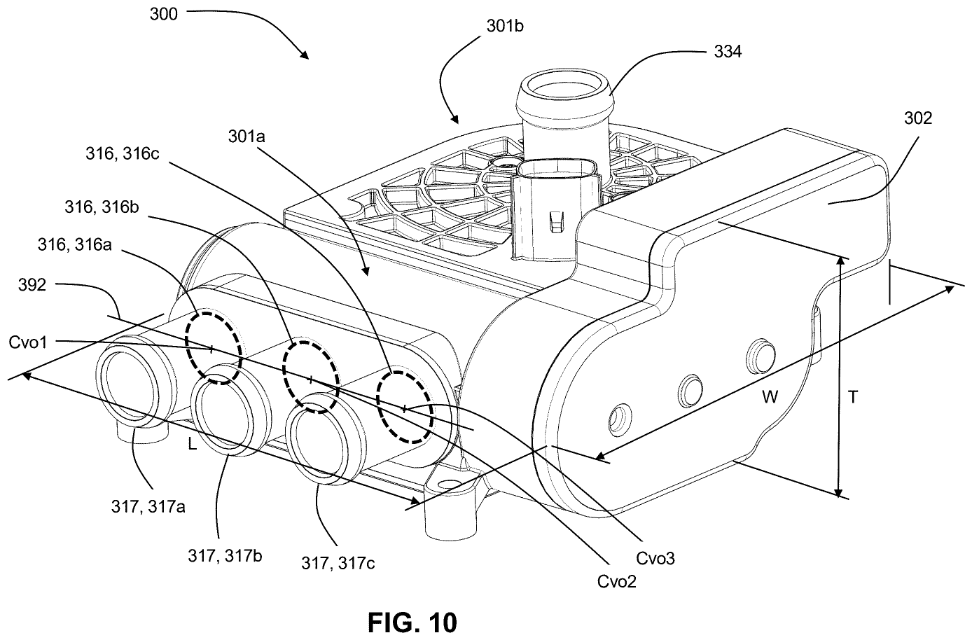

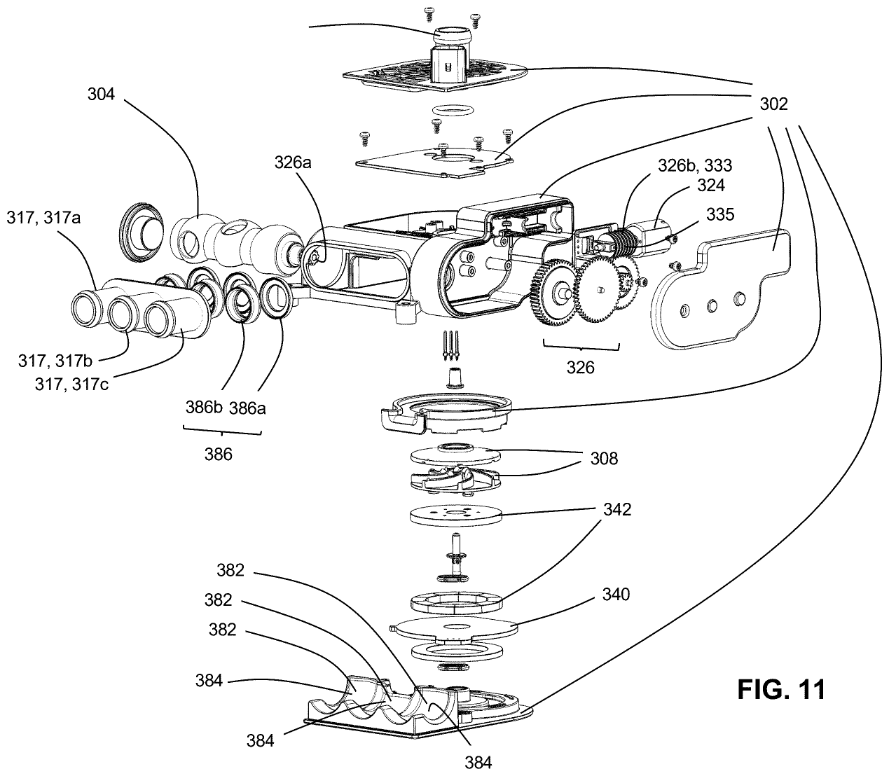

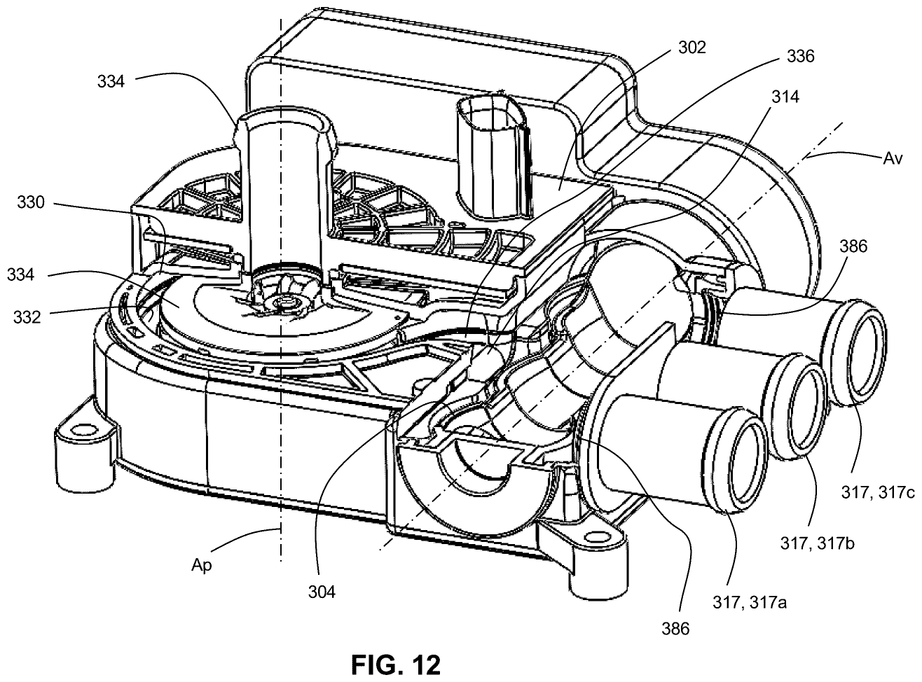

Reference is made to FIG. 10-16, which shows a valve-and-pump module 300 in accordance with another embodiment of the present disclosure. The valve-and-pump module 300 is usable in another configuration of a thermal management system that may be used for for the electric vehicle 10 (FIG. 9) for controlling a temperature of a plurality of thermal loads 22 (FIG. 1) in the electric vehicle 10 (FIG. 9). As best seen in FIG. 12, the valve-and-pump module 300 includes a valve 301a and a pump 301b. As best seen in the exploded view in FIG. 11, the valve-and-pump module 300 includes a valve-and-pump module housing 302, a valve member 304, a valve actuator 306, a pump impeller 308 and a pump driver 310.

The valve-and-pump module housing 302 may be formed from a plurality of elements as can be seen in FIG. 11. The valve-and-pump module housing 302 defines a valve chamber 312, and has at least one valve inlet 314, and a plurality of valve outlets 316, shown individually at 316a, 316b, and 316c. In the example shown, the valve-and-pump module housing 302 includes one valve inlet 314 shown best in FIG. 12 and three valve outlets 316. For each of the valve outlets 316 there may be an optionally provided valve outlet conduit 317, and for the valve inlet 316 there may be an optionally provided valve inlet conduit 319. As shown there are three valve outlet conduits 317a, 317b and 317c, which extend from the three valve outlets 316a, 316b, and 316c, respectively, and the valve inlet conduit 319, which extends from the valve inlet 314.

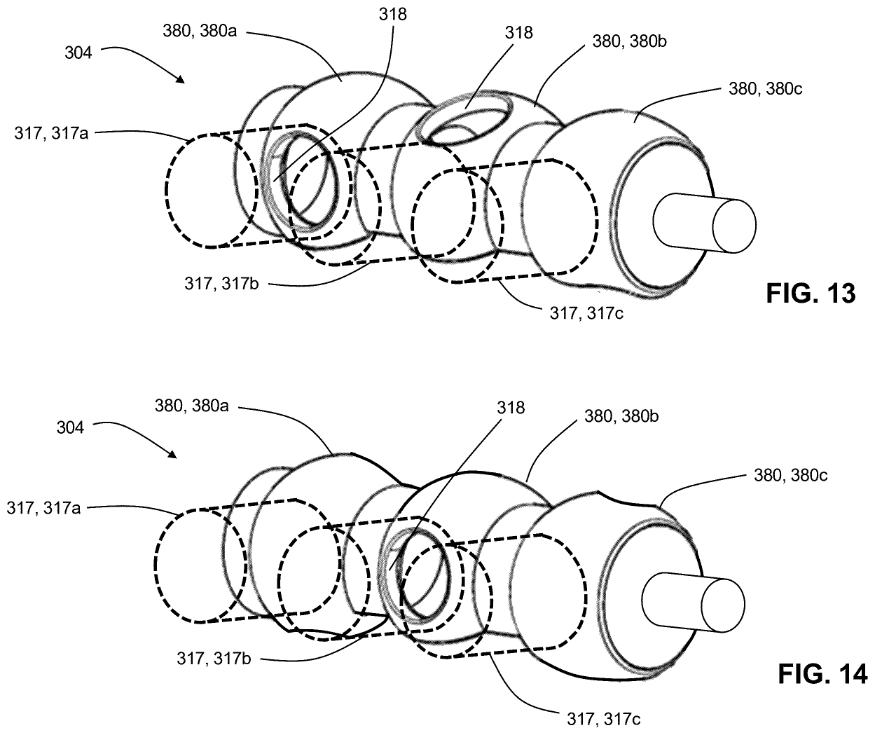

The valve member 304 is positioned in the valve chamber 312, and is rotatable about a valve member axis Av between a first position (shown in FIG. 12) and a second position (shown in FIG. 13). The valve member 304 includes a plurality of valve member spherical portions 380. In the embodiment shown, the valve member 304 includes a first valve member spherical portion 380a, a second valve member spherical portion 380b and a third valve member spherical portion 380c. Each valve member spherical portion 380 includes a valve pass-through aperture 318.

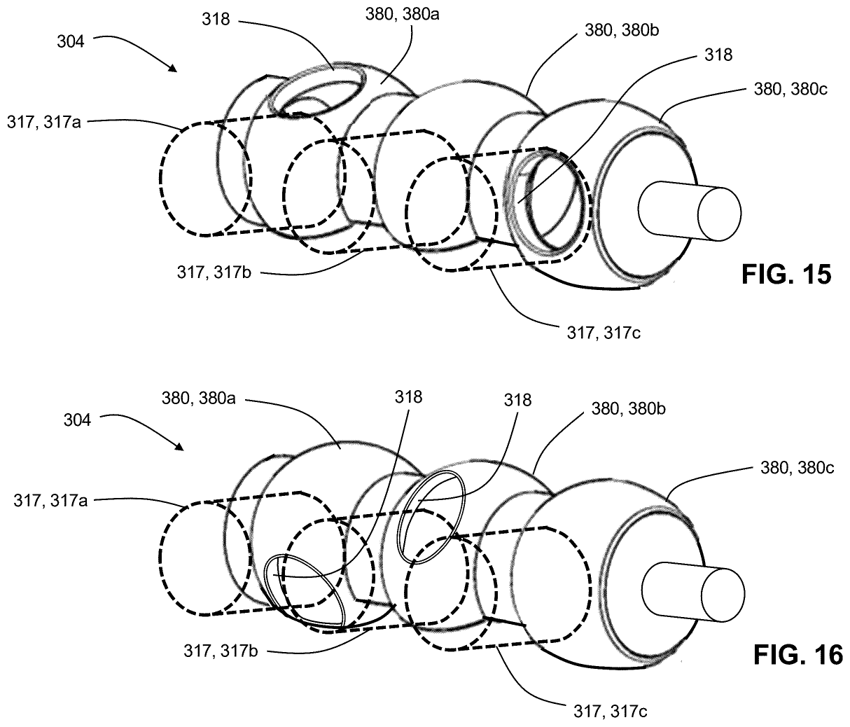

FIGS. 13-16 show the valve member 304 in a plurality of different positions, and a representation in dashed lines of the plurality of valve outlet conduits 317. The valve pass-through apertures 318 through the valve member spherical portions 380 are oriented such that rotation of the valve member 304 to a first position (e.g. any one of FIGS. 13-16, such as FIG. 13) fluidically connects the at least one valve inlet 316 to the plurality of valve outlets 316 in a first way to provide a first flow arrangement through the coolant transport system, and such that rotation of the valve member 304 to a second position (e.g. any other one of FIGS. 13-16, such as FIG. 14) fluidically connects the at least one valve inlet 314 to the plurality of valve outlets 316 in a second way to provide a second flow arrangement through the coolant transport system that is different than the first flow arrangement. Furthermore, rotation of the valve member 304 to a third position (e.g. any further other one of FIGS. 13-16, such as FIG. 16, or FIG. 15) fluidically connects the at least one valve inlet 314 to the plurality of valve outlets 316 in a third way to provide a second flow arrangement through the coolant transport system that is different than the first flow arrangement. For example, in the position shown in FIG. 13, the valve pass-through aperture 318 of the first valve member spherical portion 380a is oriented to fluidically connect the valve inlet 314 to the first valve outlet 316a, while the valve pass-through apertures 318 of the second and third valve member spherical portions 380b and 380c are oriented to prevent flow to the second and third valve outlets 316b and 316c. In the position shown in FIG. 14, the valve pass-through aperture 318 of the second valve member spherical portion 380b is oriented to fluidically connect the valve inlet 314 to the second valve outlet 316b, while the valve pass-through apertures 318 of the first and third valve member spherical portions 380a and 380c are oriented to prevent flow to the first and third valve outlets 316a and 316c. In the position shown in FIG. 15, the valve pass-through aperture 318 of the third valve member spherical portion 380c is oriented to fluidically connect the valve inlet 314 to the third valve outlet 316c, while the valve pass-through apertures 318 of the first and second valve member spherical portions 380a and 380b are oriented to prevent flow to the first and second valve outlets 316a and 316b. In the position shown in FIG. 16, the valve pass-through apertures 318 of the first and second valve member spherical portions 380a and 380b are oriented to fluidically connect the valve inlet 314 to the first and second valve outlets 316a and 316b, while the valve pass-through aperture 318 of the third valve member spherical portion 380c is oriented to prevent flow to the third valve outlet 316c. It will be understood that, while FIG. 13 has been given as an example of the first position, FIG. 14 has been given as an example of the second position, and FIGS. 15 and 16 have been given as examples of the third position, any of FIGS. 13-16 may be representative of a first, a second, a third, and a fourth position.

As best seen in FIG. 11, each of the valve member spherical portions 380 may be positioned in an associated spherical sub-chamber 382 defined by a sub-chamber wall 384. In the embodiment shown, the interior of the valve member 304 may be hollow so as to permit flow of the coolant from the valve inlet 314 into all of the valve member spherical portions 380 in all positions of the valve member 304. To permit flow out from the valve member 304 only in the desired one of the valve outlets 316, a valve outlet seal member 386 may be provided and positioned between each of the valve member spherical portions 380 and the sub-chamber wall 384 of the associated spherical sub-chamber 382 so as to form an outlet seal therebetween. As can be seen, the valve outlet seals 386 are circular. As a result, the valve outlet seals 386 are easier to manufacture, and are easier to ensure form a uniform seal, than with valves of the prior art. For example, some valves with a plurality of outlets employ a cylindrical valve member, in a cylindrical chamber. However, seals that are formed between the cylindrical valve member and the cylindrical housing are not typically circular, since the shape of the inlet to the outlet conduit from the valve is not circular but is instead the shape of a circle that has been wrapped around a cylinder. As a result, the seal is more difficult to manufacture, or typically will have regions of greater stress and regions of lesser stress, making for uneven sealing performance. By providing the valve member such as the valve member 304 with a plurality of valve member spherical portions 380, that sit in the associated spherical sub-chambers 382, the seals may be circular and can provide even performance all along their length making it easier to inhibit leakage past the valve member 304.

Each of the valve outlet seals 386 may be connected to the housing 302 by means of a seal connector 387, which may, for example be a generally cylindrical member that captures the valve outlet seal 386 therein at one end and which extends into the associated valve outlet conduit 317.

The valve actuator 306 includes a valve actuator motor 324, and a valve actuator gear arrangement 326 that includes a final gear 326a that is positioned for rotation about the valve member axis Av and is operatively connected to the valve member 304 to rotate the valve member 304 between the first and second positions (or worded another way, between however many positions the valve member 304 is rotatable to).

The valve actuator gear arrangement 326 further includes an initial gear 326b, which may be a worm 333. The worm 333 includes a flight 335 that is shaped so as to be non-backdrivable so as to permit the valve actuator motor 324 to hold the valve member 304 in one of the first and second positions while the valve actuator motor 324 is deenergized.

Referring to FIG. 12, the valve-and-pump module housing 302 defines a pump chamber 330 that has a volute 332 and defines a pump axis Ap. The valve-and-pump module housing has a pump inlet 334 that extends axially along the pump axis Ap and a pump outlet 336 that extends tangentially relative to the volute 332 and is fluidically upstream from the at least one valve inlet 314.

The pump impeller 308 is positioned in the pump chamber 330 for rotation about the pump axis Ap, and is shaped so as to drive coolant from the pump inlet 334 through the volute 332 to the pump outlet 336.

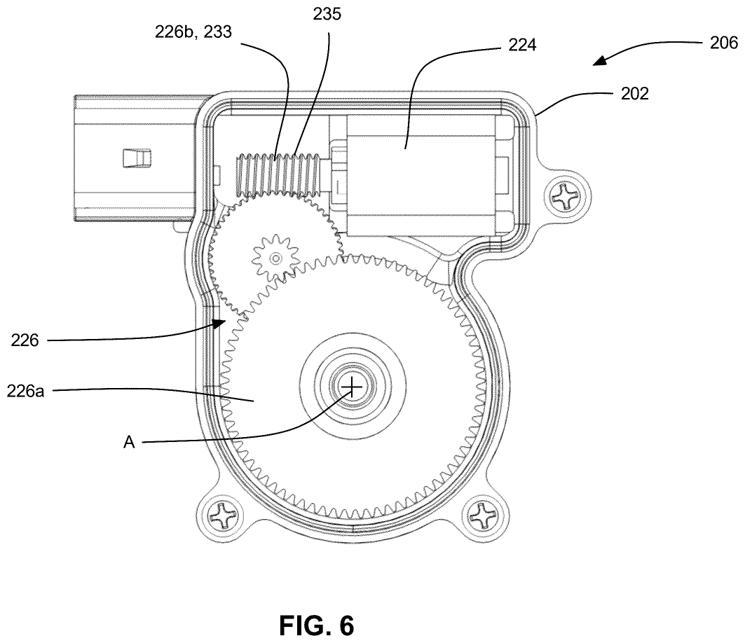

The pump driver 310 may include an axial flux motor 338 including a stator 340 that is connected to the valve-and-pump module housing 302, and a rotor 342 that is connected to and coaxial with the pump impeller 308. The rotor 342 is rotatable by energizing the stator 340 to drive rotation of the pump impeller 308. The rotor 342 and the stator 340 may be PCBs or may have any other suitable construction. The aforementioned components, which are included in the pump 301a may be similar to their counterpart elements in the embodiment shown in FIGS. 2-8. To give specific examples, the pump chamber 330, the pump impeller 308, and the pump driver 310 may be similar to the pump chamber 230, the pump impeller 208, and the pump driver 210, respectively.

An advantage of the valve-and-pump module 300 shown in FIGS. 10-16 is that the arrangement of the components thereof is particularly compact and easy to incorporate into a thermal management system by a vehicle assembler because of several features. Firstly, the valve outlets 316 are all aligned such that their respective centers shown at Cvo1, Cvo2 and Cvo3 all extend in a straight line as can be seen by the straight line shown at 392 in FIG. 10.

As best seen in FIGS. 10, 11 and 12, the valve-and-pump module 300 may be said to have a thickness T in a thickness direction that is parallel to the pump axis Ap, a length L in a length direction that is perpendicular to the thickness direction, and a width W in a width direction that is perpendicular to both the thickness direction and the length direction. The valve member 304 extends in the length direction along a first side edge 388 of the pump chamber 330, and the valve actuator 306 extends in the width direction along a second side edge 390 of the pump chamber 330.

Those skilled in the art will appreciate that the embodiments disclosed herein can be modified or adapted in various other ways whilst still keeping within the scope of the appended claims.

What is claimed is:

1. A valve-and-pump module for controlling a flow of coolant in a thermal management system for a vehicle, comprising:
a valve-and-pump module housing defining a valve chamber, and having a plurality of valve inlets and a valve outlet,
a valve member positioned in the valve chamber and having at least one pass-through aperture, wherein the valve member is rotatable about a valve member axis between a first position in which the at least one pass-through aperture fluidically connects the plurality of valve inlets to the valve outlet in a first way to provide a first flow arrangement through the coolant transport system, and a second position in which the at least one pass-through aperture fluidically connects the plurality of valve inlets to the valve outlet in a second way to provide a second flow arrangement through the coolant transport system that is different than the first flow arrangement,
wherein the at least one pass-through aperture has at least one inlet end and at least one outlet end, and extends radially inward from the at least one inlet end towards the valve member axis and axially inward from the at least one outlet end;
a valve actuator including a valve actuator motor, and a valve actuator gear arrangement that includes a final gear that is positioned for rotation about the valve member axis and is operatively connected to the valve member to rotate the valve member between the first and second positions, wherein the valve actuator is on a first axial side of the valve member;
wherein the valve-and-pump module housing defines a pump chamber having a volute, wherein the valve-and-pump module housing has a pump inlet that extends axially and a pump outlet that extends tangentially, wherein the pump inlet is coaxial with and fluidically connected to the valve outlet;
a pump impeller that is positioned in the pump chamber for rotation about a pump impeller axis that is coaxial with the valve member axis, wherein the pump impeller is shaped so as to drive coolant from the pump inlet through the volute to the pump outlet;
a pump driver including an axial flux motor including a stator that is connected to the valve-and-pump module housing, and a rotor that is connected to and coaxial with the pump impeller, wherein the rotor is rotatable by energizing the stator, to drive rotation of the pump impeller.

2. The valve-and-pump module as claimed in claim 1, wherein the stator and the rotor are PCBs.

3. The valve-and-pump module as claimed in claim 1, wherein the valve member has an exterior surface that is generally spherical.

4. The valve-and-pump module as claimed in claim 1, wherein the valve-and-pump module housing includes a single contiguous valve-to-pump member that defines at least part of the valve chamber, the valve inlets, the valve outlet, at least part of the pump chamber, the pump inlet, and the pump outlet.

5. The valve-and-pump module as claimed in claim 1, wherein the valve actuator includes an initial gear that is directly driven by the valve actuator motor, wherein the initial gear is a worm.

6. The valve-and-pump module as claimed in claim 1, wherein the worm includes a flight that is shaped so as to be non-backdrivable so as to permit the valve actuator motor to hold the valve member in one of the first and second positions while the valve actuator motor is deenergized.

7. The valve-and-pump module as claimed in claim 1, wherein the plurality of valve inlets is three valve inlets which are positioned 120 degrees apart circumferentially about the valve member axis.

8. The valve-and-pump module as claimed in claim 1, wherein the valve member has an exterior surface, and wherein, for each valve inlet of the plurality of valve inlets, the valve-and-pump module includes a valve inlet conduit mounted to the valve-and-pump module housing, wherein the valve inlet conduit has a conduit outlet, and has an outlet-surrounding surface that surrounds the conduit outlet,
wherein the first outlet-surrounding surface extends from a high region, and is sloped towards a low region, wherein the low region is at greater depth into the seal support surface than is the high region, and is closer to the conduit outlet than is the high region,
a seal member, wherein the seal member includes a seal member body having a valve member engagement surface positioned to slidingly engage the exterior surface of the valve member, wherein the seal member further includes a leg, wherein the leg is engaged with the outlet-surrounding surface and is flexed in bending by engagement therewith.

9. The valve-and-pump module as claimed in claim 8, wherein the seal member is made from a first material at the valve member engagement surface, which has a first coefficient of friction with the valve member, and wherein the leg is made from a second material, which has a second coefficient of friction with the outlet-surrounding surface, wherein the second coefficient of friction is higher than the first coefficient of friction.

10. The valve-and-pump module as claimed in claim 9, wherein the seal member is made from PTFE at the valve member engagement surface and wherein the leg is made from a rubber.

11. The valve-and-pump module as claimed in claim 4, wherein the valve-and-pump module housing includes a valve chamber cover that sealingly mates with the single contiguous valve-to-pump member so seal a first end of the valve chamber, and further includes a valve actuator housing that houses the valve actuator motor, and a valve actuator gear arrangement.

12. A valve-and-pump module for controlling a flow of coolant in a thermal management system for a vehicle, comprising:
a valve-and-pump module housing defining a valve chamber, and having at least one valve inlet, and a plurality of valve outlets,
a valve member positioned in the valve chamber, wherein the valve member is rotatable about a valve member axis between a first position and a second position, wherein the valve member includes a plurality of valve member spherical portions, each including a valve pass-through aperture,
wherein the valve pass-through apertures are oriented such that rotation of the valve member to the first position fluidically connects the at least one valve inlet to the plurality of valve outlets in a first way to provide a first flow arrangement through the coolant transport system, and such that rotation of the valve member to the second position fluidically connects the at least one valve inlet to the plurality of valve outlets in a second way to provide a second flow arrangement through the coolant transport system that is different than the first flow arrangement,
wherein each of the valve member spherical portions is positioned in an associated spherical sub-chamber defined by a sub-chamber wall;
a valve outlet seal member positioned between each of the valve member spherical portions and the sub-chamber wall of the associated spherical sub-chamber so as to form an outlet seal therebetween, wherein the valve outlet seals are circular;
a valve actuator including a valve actuator motor, and a valve actuator gear arrangement that includes a final gear that is positioned for rotation about the valve member axis and is operatively connected to the valve member to rotate the valve member between the first and second positions,
wherein the valve-and-pump module housing defines a pump chamber having a volute and defining a pump axis, wherein the valve-and-pump module housing has a pump inlet that extends axially along the pump axis and a pump outlet that extends tangentially relative to the volute and is fluidically upstream from the at least one valve inlet;
a pump impeller that is positioned in the pump chamber for rotation about the pump axis, wherein the pump impeller is shaped so as to drive coolant from the pump inlet through the volute to the pump outlet; and
a pump driver including an axial flux motor including a stator that is connected to the valve-and-pump module housing, and a rotor that is connected to and coaxial with the pump impeller, wherein the rotor is rotatable by energizing the stator, to drive rotation of the pump impeller.

13. The valve-and-pump module as claimed in claim 12, wherein the plurality of valve member spherical portions includes at least a first valve member spherical portion, a second valve member spherical portion, and a third valve member spherical portion, and wherein the valve member is further rotatable to a third position in which the valve member fluidically connects the at least one valve inlet to the plurality of valve outlets in a third way to provide a third flow arrangement through the coolant transport system that is different than the first flow arrangement and the second flow arrangement.

14. The valve-and-pump module as claimed in claim 12, wherein the plurality of valve member spherical portions includes at least a first valve member spherical portion, and a second valve member spherical portion, and wherein in at least one of the first and second positions the valve member fluidically connects the at least one valve inlet to a first one of the plurality of valve outlets and to a second one of the plurality of valve outlets through both the first valve member spherical portion and the second valve member spherical portion.

15. The valve-and-pump module as claimed in claim 12, wherein the valve-and-pump module housing has a thickness in a thickness direction parallel to the pump axis, a length in a length direction that is perpendicular to the thickness direction, and a width in a width direction that is perpendicular to both the thickness direction and the length direction,
wherein the valve member extends in the length direction along a first side edge of the pump chamber, and the valve actuator extends in the width direction along a second side edge of the pump chamber.

16. The valve-and-pump module as claimed in claim 13, wherein the plurality of valve outlets includes at least three valve outlets, and wherein each of the plurality of valve outlets has a center, wherein the centers of the plurality of valve outlets extend in a straight line.

17. The valve-and-pump module as claimed in claim 12, wherein the stator and the rotor are PCBs.

18. The valve-and-pump module as claimed in claim 12, wherein the valve actuator includes an initial gear that is directly driven by the valve actuator motor, wherein the initial gear is a worm.

19. The valve-and-pump module as claimed in claim 12, wherein the worm includes a flight that is shaped so as to be non-backdrivable so as to permit the valve actuator motor to hold the valve member in one of the first and second positions while the valve actuator motor is deenergized.
